(19) United States
(12) Patent Application Publication
(10) Pub. No.: US 2010/0115771 A1
(43) Pub. Date: May 13, 2010

(54) HEAT EXCHANGER, HEAT EXCHANGER TUBES AND METHOD

(76) Inventors: Mark Johnson, South Milwaukee, WI (US); Craig Grohman, Muskego, WI (US); Greg Kohler, Waterford, WI (US); Edward Robinson, Caledonia, WI (US); Doug Krimmer, Oak Creek, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/615,739

(22) Filed: Nov. 10, 2009

Related U.S. Application Data
(60) Provisional application No. 61/112,868, filed on Nov. 10, 2008.

(51) Int. Cl. B23P 15/26

(52) U.S. Cl. 29/890.052; 29/890.053

(57) ABSTRACT

A method of manufacturing a heat exchanger core, including providing a plurality of flat tubes having a plurality of flow channels therein, forming at least a portion of each of said flat tubes to define an arcuate tube cross-section, piercing a first and a second header to produce a series of slotted openings therein, assembling the first and second headers to first and second ends, respectively, of the plurality of tubes, and placing the assembled tubes and headers into an elevated temperature environment to cause a braze alloy cladding on either the tubes or the headers or the tubes and the headers to flow and form brazed joints between the tubes and headers. Forming the portion of each of said flat tubes to define the arcuate tube cross-section includes forming an arc extending between an air inlet side and an air outlet side of the tube.

### CROSS-REFERENCE TO RELATED APPLICATIONS

The present application claims priority to U.S. Provisional Patent Application Ser. No. 61/112,868, filed Nov. 10, 2008, the entire contents of which is hereby incorporated by reference.

### FIELD OF THE INVENTION

The present invention relates generally to finless heat exchangers, and particularly relates to microchannel finless heat exchangers for use as low-fouling condensers in refrigeration and air conditioning systems.

### BACKGROUND OF THE INVENTION

Vapor compression systems are commonly used for refrigeration and air conditioning. In a typical system of this kind, a refrigerant is circulated through a continuous thermodynamic cycle in order to transfer heat energy from a temperature and/or humidity controlled environment to an uncontrolled ambient environment.

At one particular point in the cycle, heat is rejected to the uncontrolled ambient environment by condensing the refrigerant from a superheated high-pressure vapor to a sub-cooled high-pressure liquid in a condenser. This condenser is often an air-cooled heat exchanger, wherein the refrigerant is placed in heat transfer relation with a flow of air from the uncontrolled environment that is induced to pass through the heat exchanger.

It has been found that in many such applications the flow of air from the uncontrolled environment may have various types of debris entrained within it. Due to the very nature of the ambient environment being uncontrolled, a large variety of debris such as, for example, dust, dirt, hair, fibers, pollen, etc. may be passed through the condenser along with the air flow. This can result in fouling of the condenser's air-side heat transfer surfaces, wherein the debris passing through the condenser builds up on the surfaces and impedes the effective transfer of heat from the refrigerant to the air. If the air channels are small enough, this fouling debris can bridge the channels and can eventually result in the air channels being substantially blocked, leading to poor performance of the system.

A common solution to the aforementioned problem is to construct the condenser as a round tube and plate fin style heat exchanger with a large spacing between adjacent fins so that complete blockage of the air flow channels between the fins is not likely to occur. However, such a large fin spacing both reduces the available heat transfer surface area and allows for much of the air to pass directly through the condenser without contacting the fins, thereby compromising the heat exchange effectiveness of the condenser. As a result, such a low-fouling condenser typically has to be increased in size in order to achieve the required performance.

### SUMMARY OF THE INVENTION

In some embodiments, the present invention provides a heat exchange core with a core inlet face and a core outlet face. The core inlet and outlet faces are parallel to one another, and are spaced apart to define a core depth. The heat exchange core includes a pair of headers and multiple tubes extending between the headers. Inside of the tubes is a first flow path to allow a fluid flow to pass through the core from one header to the other header. This first flow path is located between the core inlet face and the core outlet face, and has a flow direction that is parallel to the core faces. The tubes are spaced apart from one another in a direction perpendicular to that flow direction, so that a second flow path is defined between the tubes. This second flow path extends from the core inlet face to the core outlet face, and includes an upstream portion and a downstream portion. The flow direction of the upstream portion is not parallel to the flow direction of the downstream portion, but both are perpendicular to the flow direction of the first flow path.

In some embodiments, the heat exchange core may be used as a low fouling core for a condenser heat exchanger. A pressurized refrigerant may flow through the first flow path and transfer heat to air flowing through the second flow path. In other embodiments the heat exchange core may be used as a core for an evaporator heat exchanger, and air flowing through the second flow path may transfer heat to a refrigerant passing through the first flow path. In still other embodiments the heat exchange core may be used in other types of heat exchangers to transfer heat between other fluids.

In some particular embodiments, the included angle between the flow direction of the upstream portion of the second flow path and the core inlet face may be approximately equal to the included angle between the flow direction of the downstream portion of the second flow path and the core outlet face.

In some particular embodiments, each of the tubes has a first end portion connected to one header and a second end portion connected to the other header. Each tube further includes a center portion located between the first and second end portions, with the center portion having an arcuate cross-section. In some such embodiments at least one of the first and second end portions can have a non-arcuate cross-section.

In some embodiments of the invention a low-fouling heat exchanger can include two heat exchange cores, with the core inlet face of the second heat exchange core located adjacent to the core exit face of the first heat exchange core. In some such embodiments, the first flow path of the first heat exchange core may be fluidly connected to the first flow path of the second heat exchange core. In some embodiments a low-fouling heat exchanger can include more than two heat exchanger cores.

Other aspects of the invention will become apparent by consideration of the detailed description and accompanying drawings.

### BRIEF DESCRIPTION OF THE DRAWINGS

FIG. 1 is a perspective view of a heat exchanger core according to one embodiment of the invention.

FIG. 2 is a perspective view of a tube capable of being used in the heat exchange core of FIG. 1.

FIG. 3 is a side elevation view of the tube of FIG. 2.

FIG. 4 is a partial section view taken along the lines IV-IV of FIG. 1.

FIG. 5 is an exploded perspective view of the heat exchanger core of FIG. 1.

FIG. 6 is a perspective view of a heat exchanger making use of the heat exchanger core of FIG. 1.

FIG. 7 is a perspective view of an other tube capable of being used in the heat exchange core of FIG. 1.

### DETAILED DESCRIPTION OF THE PREFERRED EMBODIMENT

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

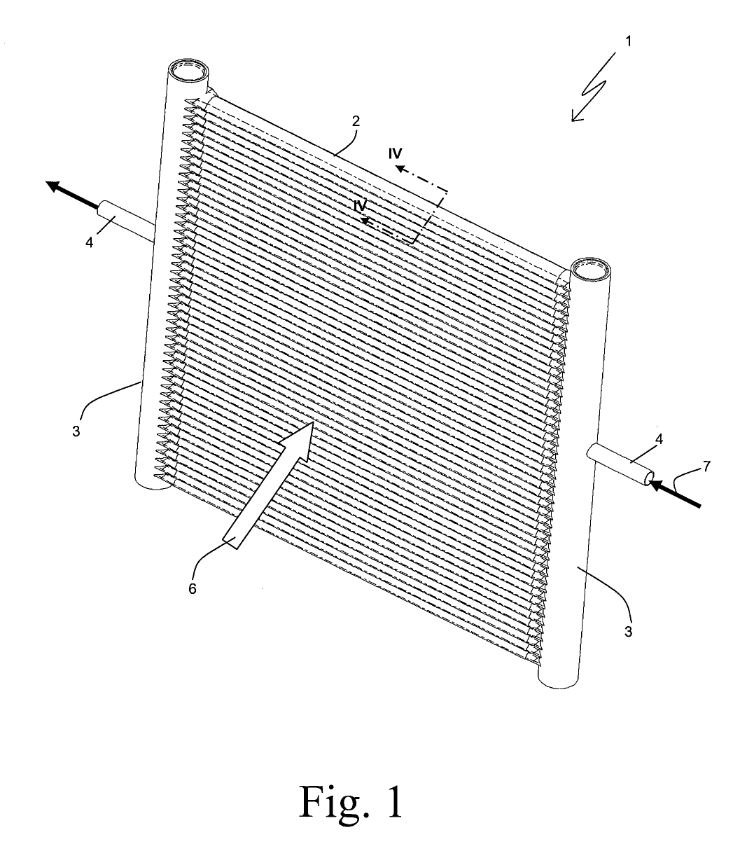

FIG. 1 illustrates a heat exchange core 1 according to one embodiment of the present invention. The core 1 has a plurality of heat exchange tubes 2 extending between first and second headers 3 to convey a fluid 7 through the core 1. A port 4 is provided at each of the headers 3 to allow the fluid 7 to enter and exit the heat exchange core 1.

Although the embodiment of FIG. 1 shows a single port 4 at each header 3, it should be understood by those having skill in the art of heat exchangers that, depending on the particular application, multiple ports 4 may be provided at one or both of the headers 3. Furthermore, it should be understood that the preferred orientation of the ports 4 relative to the headers 3 and/or the tubes 2 may also vary depending on the specific application. In addition, baffles may be placed within one or more of the headers 3 in order to divide the plurality of heat exchange tubes into two or more passes of tubes 2 in series. In some cases, this could result in both ports 4 being located within the same header 3.

A heat exchange core 1 according to the present invention may find utility as a low fouling core in an air conditioning or refrigeration condenser, or as a frost-proof core in a low-temperature evaporator such as might be used in a refrigeration application. In certain applications, such as when the core 1 is to be used in a condenser or evaporator for air conditioning or refrigeration systems, the fluid 7 may be a refrigerant. In other applications, the fluid 7 may be an alternate fluid, including but not limited to a liquid coolant, charge air, or a Rankine cycle working fluid.

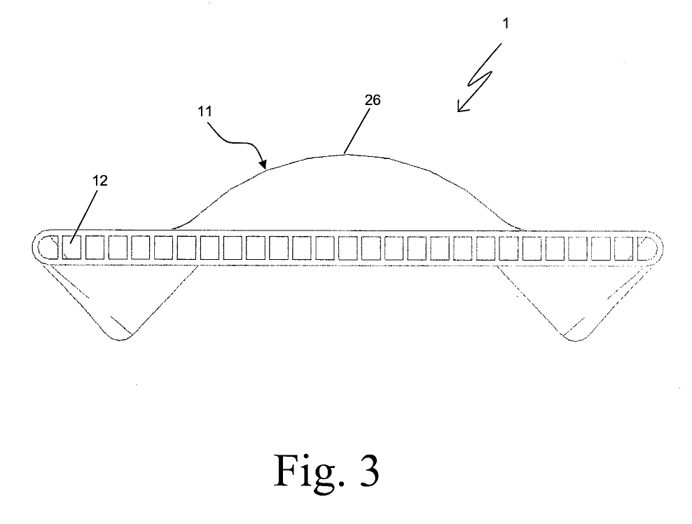

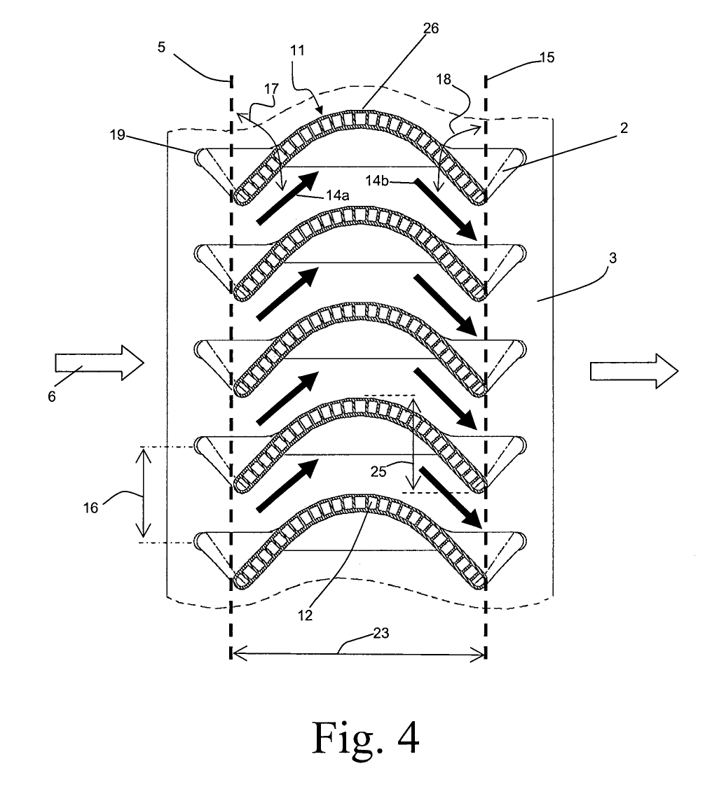

The tubes 2 define a flow path 13 to convey the fluid 7 through the heat exchange core 1. As best seen in FIGS. 3 and 4, the flow path 13 has a plurality of individual flow channels 12 located within the tubes 2. Although the exemplary embodiment shows channels 12 having a rectangular cross-section, it should be apparent to those having skill in the art that other channel geometries, such as for example round or triangular, may also be suitable. In some embodiments the channels 12 may provide a hydraulic diameter of less than 1 mm, sometimes referred to as a “microchannel”.

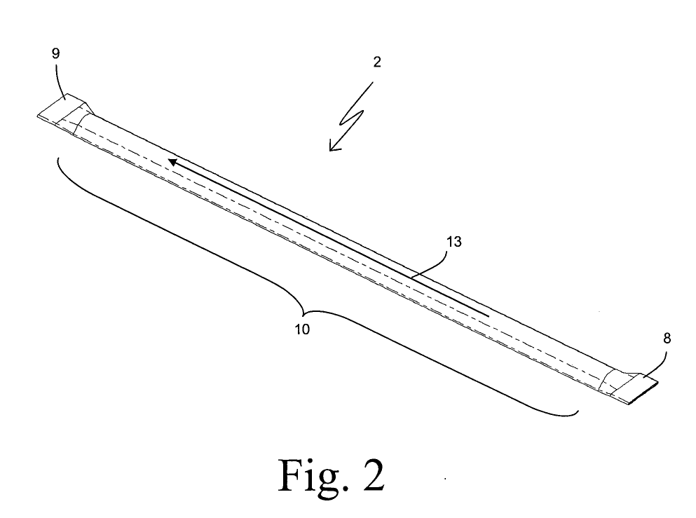

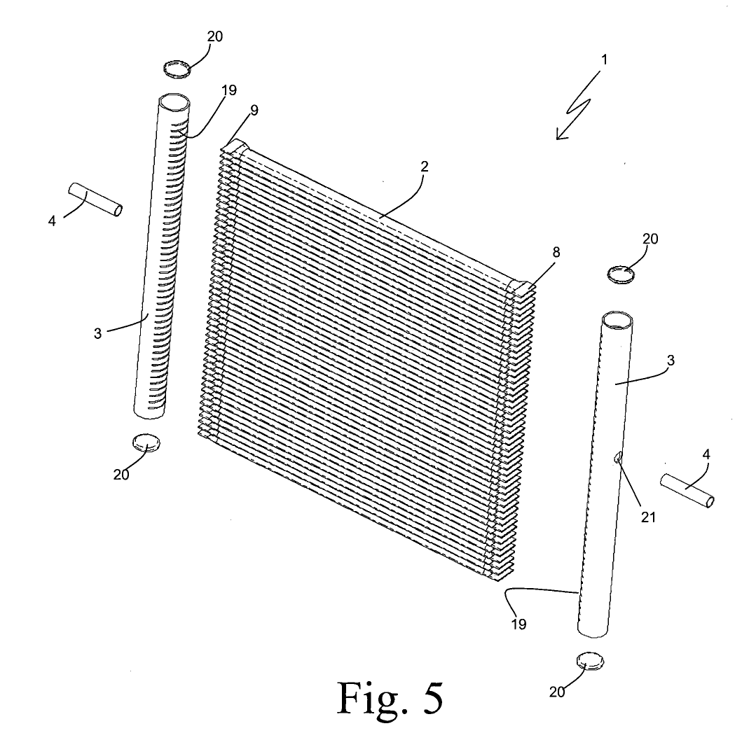

As shown in FIG. 2, each tube 2 includes a first end section 8, a second end section 9, and a center section 10 located between the end sections 8 and 9. The first end sections 8 of the plurality of tubes 2 are received into a plurality of slots 19 (FIG. 5) in one of the headers 3 in order to receive the fluid 7 from the one of the headers 3 into the channels 12. Similarly, the second end sections 9 of the plurality of tubes 2 may be received into a plurality of slots 19 (FIG. 5) in the other of the headers 3 in order to discharge the fluid 7 from the channels 12 into the other of the headers 3. While the headers 3 in the exemplary embodiments are depicted as round headers, it should be understood that other styles of headers, such as for example flat plate headers, may be used depending on the requirements of the particular application.

As best seen in FIGS. 3 and 4, the center portion 10 of the tubes 2 has an arcuate profile 11. While in some embodiments the arcuate profile 11 may have a true circular segment, in other embodiments the arcuate profile may have other shapes such as parabolic, ellipsoid, catenary, etc. In the exemplary embodiment of FIG. 2 the end segments 8 and 9 are shown as having non-arcuate profiles. However, in other embodiments one or both of the end sections 8 and 9 may have an arcuate profile as well.

The plurality of tubes 2, once inserted into the slots 19 of the headers 3, define a core face inlet plane 5 and a core face outlet plane 15. As best seen in FIG. 4, the core face inlet plane 5 and core face outlet plane 15 are parallel to one another and define a core depth distance 23 between the planes. In the illustrated construction, the core depth distance is approximately 24 mm. In other constructions, the core depth distance 23 may be between approximately 18 mm and approximately 40 mm. As best illustrated in FIG. 4, the center portion 10 of the tubes 2 includes a peak 26 located approximately equidistantly from the core face inlet plane 5 and the core face outlet plane 15. In other words, the peak 26 is located approximately centrally between the core face inlet plane 5 and the core face outlet plane 15, or approximately at a midpoint of the core depth distance 23. In other constructions, the peak 26 may be off-center. Each tube 2 of the core 1 includes a single peak 26 between the core face inlet plane 5 and the core face outlet plane 15. The peaks 26 are aligned with one another in a plane that is parallel to the core inlet plane 5 and the core outlet plane 15, the plane preferably being centered between, or equidistant from, the core inlet plane 5 and the core outlet plane 15. The arcuate profile of the center portion 10 of the tubes 2 extends along a majority of the core depth distance 23 between the core inlet plane 5 and the core outlet plane 15. In the illustrated construction, the arcuate profile extends along the entire core depth distance 23 between the core inlet plane 5 and the core outlet plane 15.

Adjacent ones of the slots 19 are spaced apart by a tube pitch distance 16, the pitch distance 16 being measured from a point on one of the tubes 2 to the corresponding point on an adjacent tube 2, so that a flow path 14a, 14b is defined in the spaces between the tubes. In the illustrated construction, the pitch distance 16 is approximately 9.83 millimeters; and in other constructions, the pitch distance is preferably between approximately 6 mm and approximately 12 mm. The flow path 14a, 14b extends between the core inlet face 5 and the core outlet face 15. Due to the arcuate profile of the tubes 2, the flow path 14a, 14b includes an upstream portion 14a adjacent the core inlet face 5 and a downstream portion 14b adjacent the core outlet face 15. The upstream portion 14a and the downstream portion 14b are non-parallel to one another and non-perpendicular to the core inlet face 5 and the core outlet face 15. The flow path 13 inside of the tubes is perpendicular to the upstream portion 14a and the downstream portion 14b. A fluid 6 flows along the flow path 14 so as to be placed in heat transfer relation with the fluid 7 flowing along the flow path 13.

In the embodiment of FIG. 4, the upstream flow path portion 14a and the core inlet face 5 have an acute included angle 17, and the downstream flow path portion 14b and the core outlet face 15 have an acute included angle 18. In the exemplary embodiment, the included angles 17 and 18 are equal to one another. However, in other embodiments these angles may be non-equal. In the illustrated construction, the acute included angles 17, 18 are approximately 45 degrees. In other constructions, the acute angles are preferably between approximately 40 degrees and approximately 70 degrees.

The arcuate profile 11 causes the tube cross-section to have a height dimension 25, as shown in FIG. 4. In the illustrated construction, the height dimension 25 is approximately 10 mm; and in other constructions, the height dimension 25 may be between approximately 6 mm and approximately 12 mm. In a preferable embodiment the tube pitch distance 16 is no greater than the height 25, so that a fluid 6 is directed to follow the flow path portions 14a and 14b. In other words, when the tube pitch distance 16 is less than the height dimension 25, then no flow path will exist from the core inlet face 5 to the core outlet face 15 that is not at a non-perpendicular angle with respect to the core inlet and outlet faces.

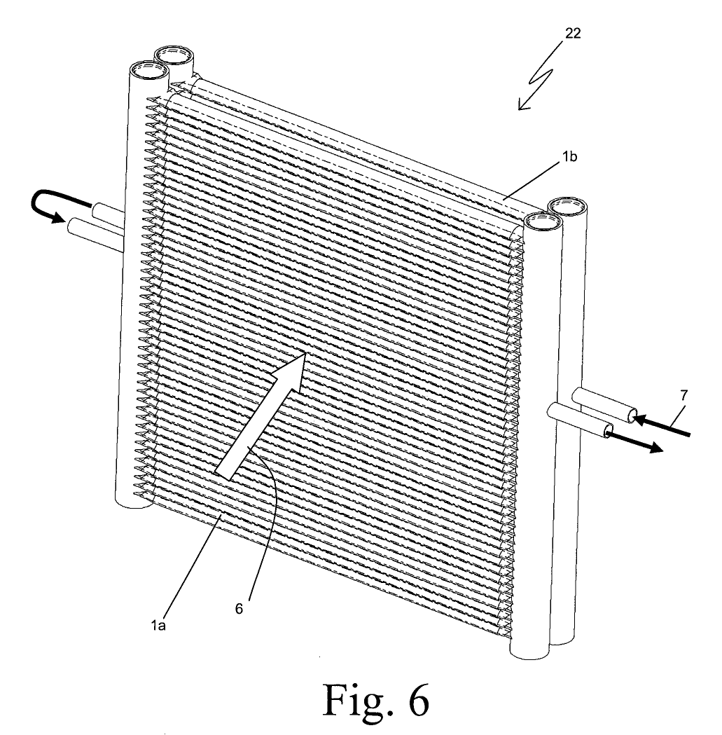

FIG. 6 depicts a heat exchanger 22 employing two of the earlier described heat exchange cores 1 (identified as 1a and 1b respectively in FIG. 6). The core 1a is located upstream of the core 1b with respect to the fluid flow 6, and the cores are arranged so that the core inlet face of the core 1b is adjacent to, and directly downstream of, the core outlet face of the core 1a. In the exemplary embodiment the two cores are arranged to be fluidly in series with respect to the fluid flow 7 as well, by having the fluid 7 exiting the core 1b be directed to enter the core 1a, thus creating a counter-crossflow arrangement between the fluids 7 and 6. In some embodiments it may be preferable for the fluid 7 to pass first through the core 1a and second through the core 1b, thus creating a concurrent-crossflow arrangement instead. In still other embodiments some other flow arrangement may be preferable, such as for example placing both cores 1a and 1b fluidly in parallel with respect to the fluid 7.

In some embodiments of the heat exchanger 22 the cores 1a and 1b may be mechanically assembled together. In other embodiments the cores 1a and 1b may be brazed together. In some embodiments the tubes 2 in the core 1a may be staggered in the tube pitch direction relative to the tubes 2 in the core 1b. In some embodiments the heat exchanger 22 may include additional heat exchange cores, while in other embodiments the heat exchanger 22 may have only a single heat exchange core 1.

Through testing, the inventors have determined that a heat exchanger according to the present invention can substantially outperform a finless heat exchanger of comparable size constructed of conventional, flat tubes. With both heat exchangers constructed using a single core operating as a two-pass cross-flow condenser, the heat exchanger embodying the present invention was able to achieve approximately 60% greater heat transfer performance than the flat tube heat exchanger was able to achieve.

Without wishing to be bound by any theory, it is believed that the redirection of the air flow while passing through the flow path portions 14a and 14b results in enhanced heat transfer due to a breaking up of the fluid boundary layer on the surfaces of the tubes. A boundary layer typically develops whenever a viscous fluid passes over long, smooth surfaces, and this boundary layer will retard the rate of convective heat transfer to or from the surface. By breaking up the boundary layer, this heat transfer resistance can be dramatically reduced.

The inventors have determined certain additional benefits provided by a heat exchanger according to the present invention over a finless heat exchanger constructed of conventional flat tubes. It was found that the arcuate cross-section of the tubes provided beneficial increased tube stiffness, such that spacers located between adjacent tubes were no longer necessary in order to maintain the tube shape after the core had undergone a brazing operation.

The inventors have determined that a single core, four-pass heat exchanger according to one embodiment of the present invention operating as a condenser is able to provide equivalent performance to a conventional two row, round-tube-plate-fin (RTPF) condenser while occupying 37.5% less depth. The RTPF condenser in one case had four fins per inch (equal to a fin pitch of 6.35 millimeters), while the exemplary heat exchanger has a tube pitch 16 of 9.83 millimeters. As described in U.S. Pat. No. 7,000,415 to Daddis, Jr. et. al., incorporated herein by reference in its entirety, a heat exchanger with greater fin or tube spacing has a lower tendency to foul than does a heat exchanger with lesser fin or tube spacing. Accordingly, it is expected that the heat exchanger embodying the present invention will be less likely to foul than the comparable RTPF heat exchanger due to the larger spacing.

The inventors have further determined that RTPF condensers of greater depth may advantageously be replaced by a heat exchanger according to the present invention including two or more heat exchange cores. For example, it was found that a heat exchanger with two cores as described above was able to replace a conventional three row, 4.5 fins per inch RPTF condenser with equivalent face area without imposing any additional pressure drop on the air.

It has been contemplated by the inventors that certain values of the included angles 17, 18 might provide optimum performance of a heat exchanger 22. Through testing the inventors have determined that a 45° included angle provides good performance, but angles as low as 40° and as high as 70° might provide similarly good performance. The optimum angle may vary by application, and will be dependant on the core depth and tube spacing as well, since at small core depth values and/or large tube spacing values a smaller angle may be required in order to guide the flow 6 along the flow path 14a, 14b. Furthermore, other considerations such as available header tooling and minimizing tube cost may also drive an optimum angle for a given application.

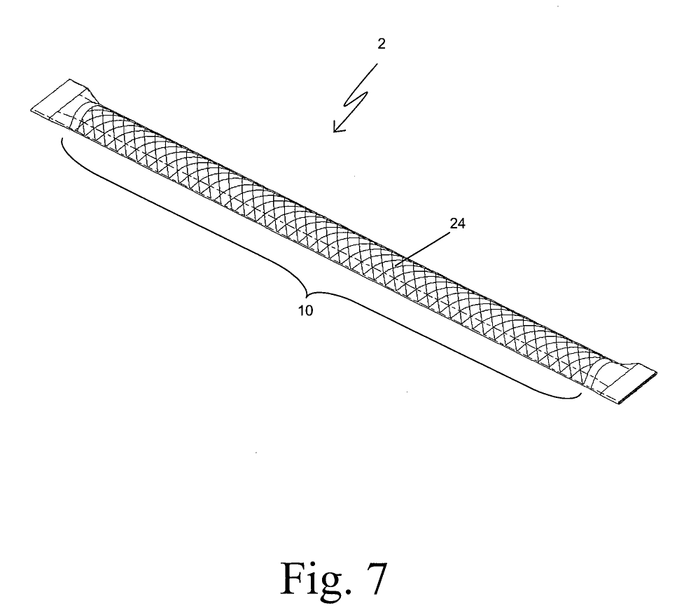

In some embodiments it may be preferable to provide turbulating features on at least some of the outer surfaces of the tubes in order to improve the heat transfer into the fluid passing over the tubes. In some embodiments wherein the tubes are extruded tubes, such turbulating features might be directly formed in the tube by the extrusion process. In other embodiments the turbulating features may be formed in a separate operation, such as for example a knurling operation. An exemplary tube 2 having a diamond knurled turbulating feature 24 applied over a portion of its outer surface is illustrated in FIG. 7.

According to another aspect of the invention, one method of manufacturing a heat exchange core includes the steps of providing a plurality of flat tubes 2 and forming at least of portion of the tubes to define an arcuate cross-section. In some embodiments the step of providing the flat tubes includes the step of extruding the flat tubes from an aluminum alloy. Another method of manufacturing a heat exchange core includes the steps of providing a plurality of arcuately shaped tubes 2 and forming flattened first and second ends 8, 9 on each tube.

A method of manufacturing a heat exchange core according to the invention further includes the step of piercing a first and second header 3 to produce a series of slotted tube openings 19, where the openings 9 have a predetermined spacing 16. In some embodiments the spacing 16 may be a constant spacing, whereas in other embodiments the spacing 16 may vary along the length of the headers 3.

A method of manufacturing a heat exchange core according to the invention may further include the step of arranging the plurality of tubes to have a spaced relation with one another, where the spaced relation is equal to and corresponds with the predetermined spacing 16. In addition, the method may include assembling the first header 3 to first ends 8 of the plurality of tubes 2 by inserting the first end 8 of each tube into one of the slots 19 in the first header 3, and assembling the second header 3 to second ends 9 of the plurality of tubes 2 by inserting the second end 9 of each tube into one of the slots 19 in the second header 3.

The method of manufacturing a heat exchange core 1 may further include placing the assembled tubes and headers into an elevated temperature environment in order to cause a braze alloy to flow and form brazed joints between the tubes and headers. In some embodiments the braze alloy may be a clad layer on the tubes 2 or on the headers 3 or on both the tubes and the headers.

According to some embodiments the method of manufacturing may further include fastening caps 20 onto one or more ends of the headers 19. In some embodiments the fastening of the one or more caps 20 onto the headers 19 may be accomplished by brazing, and in some embodiments the brazing of the caps onto the headers may be accomplished concurrent with the brazing of the tubes 2 to the headers 19.

According to some embodiments the method of manufacturing a heat exchange core may further include the step of providing a turbulating feature on a surface of the tubes 2. In some embodiments the step of providing a turbulating feature may occur after the step of providing the tubes. In some such embodiments the step of providing a turbulating feature may include knurling a surface of the tubes.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A method of manufacturing a heat exchanger core, comprising the steps of:
providing a plurality of flat tubes having a plurality of flow channels therein;
forming at least a portion of each of said flat tubes to define an arcuate tube cross-section;
piercing a first and a second header to produce a series of slotted openings therein, the slotted openings having a predetermined spacing;
arranging the plurality of tubes to have a spaced relation with one another equal to the predetermined spacing;
assembling the first header to first ends of the plurality of tubes such that the first end of each tube is inserted into one of the slotted openings of the first header;
assembling the second header to second ends of the plurality of tubes such that the second end of each tube is inserted into one of the slotted openings of the second header; and
placing the assembled tubes and headers into an elevated temperature environment to cause a braze alloy cladding on either the tubes or the headers or the tubes and the headers to flow and form brazed joints between the tubes and headers;
wherein forming the portion of each of said flat tubes to define the arcuate tube cross-section includes forming an arc extending between an air inlet side and an air outlet side of the tube.
